(19) United States
(12) Patent Application Publication
(10) Pub. No.: US 2019/0086739 A1
(43) Pub. Date: Mar. 21, 2019

(54) ARRAY SUBSTRATE AND DISPLAY PANEL INCLUDING SAME

(71) Applicant: HKC Corporation Limited, Shenzhen City, Guangdong (CN)

(72) Inventor: Beizhou HUANG, Shenzhen City, Guangdong (CN)

(21) Appl. No.: 15/739,100

(22) PCT Filed: Oct. 20, 2017
(86) PCT No.: PCT/CN2017/107029

§ 371 Date: Dec. 21, 2017

(30) Foreign Application Priority Data
Sep. 19, 2017 (CN) 201710851560.1

(51) Int. Cl. G02F 1/1343; G02F 1/1362; G02F 1/1337; G02F 1/1368; G02F 1/1335

(52) U.S. Cl. CPC G02F 1/134309; G02F 1/136286; G02F 2001/134354; G02F 1/1368; G02F 1/133514; G02F 1/133703

(57) ABSTRACT

An array substrate includes: a substrate, having a display region and a wiring region; at least one active switch, disposed on the substrate; a plurality of scanning lines and a plurality of data lines, disposed on the substrate, where the scanning lines are electrically connected to a control end of the active switch, and the data lines are electrically connected to an input end of the active switch; and a plurality of pixels, disposed on the display region and electrically connected to an output end of the active switch, where: the pixels include a VA pixel and at least one polymer-stabilized VA pixel, where: the polymer-stabilized VA pixel is a blue pixel; and a pixel electrode of the VA pixel and a pixel electrode of the polymer-stabilized VA pixel are separately electrically coupled to the substrate.

### BACKGROUND

### Technical Field

This application relates to a pixel design method, and in particular, to an array substrate and a display panel including same.

### Related Art

A liquid crystal display (LCD) panel usually includes a color filter (CF) substrate, an active switch array substrate (thin film transistor array substrate, TFT Array Substrate), and a liquid crystal layer disposed between the two substrates. A working principle of the LCD is controlling rotation of liquid crystal molecules of the liquid crystal layer by applying a driving voltage to two glass substrates, so as to refract light from a backlight module to generate an image. According to different liquid crystal orientation manners, LCD panels in the current mainstream market may be classified into the following types: a vertical alignment (VA) type, a twisted nematic (TN) or a super twisted nematic (STN) type, an in-plane switching (IPS) type, and a fringe field switching (FFS) type.

LCDs of a VA mode include, for example, a patterned vertical alignment (PVA) LCD or a multi-domain vertical alignment (MVA) LCD. The PVA LCD achieves a wide-angle view by using a fringe field effect and a compensation plate. In the MVA LCD, one pixel is divided into a plurality of domains, and liquid crystal molecules in different domains are tilted toward different directions by using a protrusion or a particular pattern structure, to achieve a wide-angle view and improve transmittance.

Moreover, LCDs are most widely used displays in the market currently, and in particular, are widely used in liquid crystal televisions. As resolution is gradually improved, a size of a pixel is increasingly small, and an opening rate is also increasingly low. Because when being viewed, a product having a large size has a relatively broad range of visible angles, when the product is viewed from a large viewing angle, a color shift phenomenon may occur.

Formerly, to resolve a large-viewing-angle color shift problem, in terms of design, there are a main pixel and a sub pixel, and 4 domains are changed into 8 domains by pulling down a voltage of the sub pixel, to improve a viewing angle. In such design, usually, three or more active switches are used to perform control.

However, in such design, as resolution is increasingly high, a pixel is increasingly small, a space occupied by active switches is increasingly large, and consequently, an opening rate is increasingly low. Therefore, to obtain a high opening rate, designing a product having a large size and high resolution to have 4 domains is gradually resumed, and then, a viewing angle is improved by using an electrical algorithm. However, such an improvement method may cause some display problems.

### SUMMARY

To resolve the foregoing technical problem, an objective of this application is to provide a pixel design method, and in particular, an array substrate and a display panel including same, so as to not only effectively resolve a color shift problem, but also effectively improve a viewing angle of a product having a large size and high resolution, thereby increasing transmittance of the product having a large size and high resolution.

The objective of this application is achieved and the technical problem of this application is resolved by using the following technical solution. An array substrate is provided according to this application, comprising: a substrate, having a display region and a wiring region; at least one active switch, disposed on the substrate; a plurality of scanning lines and a plurality of data lines, disposed on the substrate, where the scanning lines are electrically connected to a control end of the active switch, and the data lines are electrically connected to an input end of the active switch; a plurality of pixels, disposed on the display region and electrically connected to an output end of the active switch, where: the plurality of pixels comprises a VA pixel and at least one polymer-stabilized VA pixel, where: the polymer-stabilized VA pixel is a blue pixel; and a pixel electrode of the VA pixel and a pixel electrode of the polymer-stabilized VA pixel are separately electrically coupled to the substrate.

The objective of this application may further be achieved and the technical problem of this application may further be resolved by taking the following technical measures.

Another objective of this application is to provide an array substrate, comprising: a substrate, having a display region and a wiring region; at least one active switch, disposed on the substrate; a plurality of scanning lines and a plurality of data lines, disposed on the substrate, where the scanning lines are electrically connected to a control end of the active switch, and the data lines are electrically connected to an input end of the active switch; a plurality of pixels, disposed on the display region and electrically connected to an output end of the active switch, where: the plurality of pixels comprises a VA pixel and at least one polymer-stabilized VA pixel, where: the polymer-stabilized VA pixel is a blue pixel; a pixel electrode of the VA pixel and a pixel electrode of the polymer-stabilized VA pixel are separately electrically coupled to the substrate; the VA pixel and the polymer-stabilized VA pixel are arranged in an array form; the VA pixel and the polymer-stabilized VA pixel are rectangular; and the VA pixel and the polymer-stabilized VA pixel are configured in a spaced and intersecting manner.

Still another objective of this application is to provide a display panel, comprising: an opposite substrate, disposed opposite to an array substrate; a CF, comprising a plurality of color resists, and the array substrate, where the CF is configured on the opposite substrate or the array substrate.

In an embodiment of this application, the plurality of pixels comprises three pixels, comprising one polymer-stabilized VA pixel and two VA pixels, and the polymer-stabilized VA pixel further comprises three polymer-stabilized VA sub pixels.

In an embodiment of this application, the plurality of pixels comprises four pixels, comprising one polymer-stabilized VA pixel and three VA pixels.

In an embodiment of this application, the plurality of pixels comprises four pixels, comprising two polymer-stabilized VA pixels and two VA pixels.

In an embodiment of this application, the VA pixel and the polymer-stabilized VA pixel are arranged in an array form.

In an embodiment of this application, the polymer-stabilized VA pixel and the VA pixel are connected to different data lines.

In an embodiment of this application, the polymer-stabilized VA pixel and the VA pixel are connected to different scanning lines.

In an embodiment of this application, the VA pixel and the polymer-stabilized VA pixel are configured in a spaced manner or in a staggered manner.

This application may resolve a color shift problem of an LCD panel and increase an opening rate of a pixel and transmittance.

### BRIEF DESCRIPTION OF THE DRAWINGS

FIG. 1a is a schematic design diagram of an exemplary 8-domain pixel;

FIG. 1b is a diagram of an exemplary liquid crystal pixel circuit for resolving a color shift problem;

FIG. 2 is a schematic diagram of pixel arrangement according to an embodiment of this application;

FIG. 3 is a schematic diagram of pixel arrangement according to another embodiment of this application;

FIG. 4 is a schematic diagram of pixel arrangement according to another embodiment of this application;

FIG. 5 is a schematic diagram of pixel arrangement according to still another embodiment of this application;

FIG. 6 is a schematic diagram of pixel arrangement according to yet another embodiment of this application;

FIG. 7 is a schematic diagram of pixel arrangement according to yet still another embodiment of this application; and

FIG. 8 is a schematic diagram of a display panel according to an embodiment of this application.

### DETAILED DESCRIPTION

The following embodiments are described with reference to the accompanying drawings, and are used to exemplify particular embodiments for implementation of this application. Terms about directions mentioned in this application, such as “on”, “below”, “front”, “back”, “left”, “right”, “in”, “out”, and “side face”, merely refer to directions in the accompanying drawings. Therefore, the used terms about directions are used to describe and understand this application, and are not intended to limit this application.

The accompanying drawings and the description are considered to be essentially exemplary, rather than limitative. In the figures, units with similar structures are represented by using the same reference number. In addition, for understanding and ease of description, the size and the thickness of each component shown in the accompanying drawings are arbitrarily shown, but this application is not limited thereto.

In the accompanying drawings, for clarity, thicknesses of a layer, a film, a panel, an area, and the like are enlarged. In the accompanying drawings, for understanding and ease of description, thicknesses of some layers and areas are enlarged. It should be understood that when a component such as a layer, a film, an area, or a substrate is described to be “on” “another component”, the component may be directly on the another component, or there may be an intermediate component.

In addition, throughout this specification, unless otherwise explicitly described to have an opposite meaning, the word “include” is understood as including the component, but not excluding any other component. In addition, throughout this specification, “on” means that one is located above or below a target component and does not necessarily mean that one is located on the top substrated on a gravity direction.

To further describe the technical measures and functions used in the this application for achieving the predetermined application objectives, specific implementations, structures, features, and functions of an array substrate and a display panel including same provided in this application are described below in detail with reference to the accompanying drawings and preferred embodiments.

A display panel in this application may be an LCD panel, including a switch array (thin film transistor, TFT) substrate, a CF substrate, and a liquid crystal layer formed between the two substrates, or an organic light-emitting diode (OLED) panel, or a quantum dots light-emitting diode (QLED) panel.

In an embodiment, the display panel in this application may be a curved-surface display panel.

In an embodiment, a switch array (TFT) and a CF in this application may be formed on a same substrate.

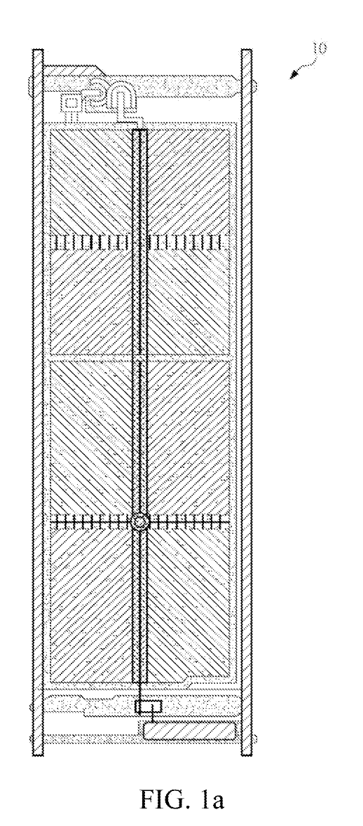

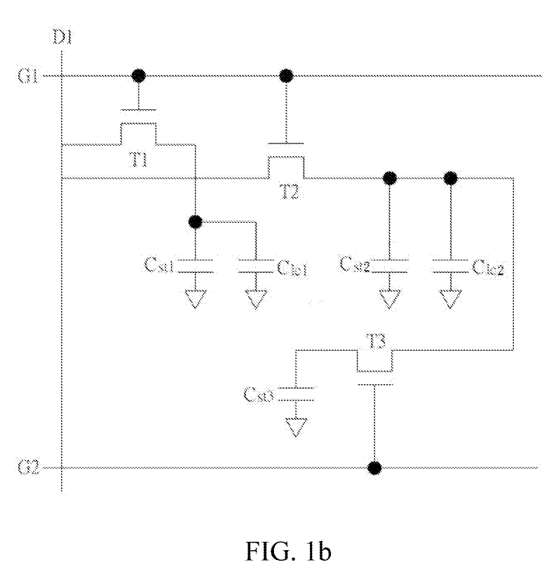

FIG. 1a is a schematic design diagram of an exemplary 8-domain pixel, and FIG. 1b is a diagram of an exemplary liquid crystal pixel circuit for resolving a color shift problem. In an LCD, performing charge sharing between a plurality of capacitors in a pixel is a technology derived for resolving a color shift problem. Referring to FIG. 1b, in the liquid crystal pixel circuit shown in FIG. 1b, a main pixel is controlled by a scanning line G1 to obtain data from a data line D1 by using a transistor T₁ and store the data into a storage capacitor Cₛₜ₁, and in addition to also being controlled by the scanning line G1 to obtain data from the data line D1 by using a transistor T₂ and store the data into a storage capacitor Cₛₜ₂, a sub pixel is further controlled by a scanning line G2 to enable, by using a transistor T₃, the storage capacitor Cₛₜ₂ and a storage capacitor Cₛₜ₃ to perform charge sharing. By means of such architecture, the liquid crystal pixel circuit shown in FIG. 1 can properly control a proportion of stored voltages of the storage capacitor Cₛₜ₁ and the storage capacitor Cₛₜ₂, so as to allow liquid crystal capacitors C_{1c1} and C_{1c2} to be driven by a default voltage, thereby eliminating a color shift problem during display. However, with updating of technologies, LCDs are also improved in terms of either resolution or a screen refresh rate. In this case, not matter whether more data in a pixel circuit needs to be updated within a same time because of higher resolution, or an original amount of data in a pixel circuit needs to be updated within a shorter time because of a higher screen refresh rate, or more data in a pixel circuit needs to be updated within a shorter time when both resolution and a screen refresh rate are higher, for each pixel circuit, a usable charging time for storing data on the data line D1 into the storage capacitors Cₛₜ₁ and Cₛₜ₂ would be reduced. Once a usable charging time for a pixel circuit is reduced, the storage capacitors Cₛₜ₁ and Cₛₑ possibly cannot be fully charged, and consequently, stored voltages of the storage capacitors Cₛₜ₁ and Cₛₜ₂ are unlikely to achieve a same level. Once the stored voltages of the storage capacitors Cₛₜ₁ and Cₛₜ₂ are different, after the storage capacitor Cₛₜ₂ and the storage capacitor Cₛₜ₃ perform charge sharing, a ratio between a voltage maintained by the storage capacitor Cₛₜ₂ and a voltage maintained by the storage capacitor Cₛₜ₁ cannot achieve an originally set proportion. Therefore, the color shift problem originally to be eliminated occurs in a display process again.

Referring to FIG. 1a, a pixel structure 10 resolving a large-viewing-angle color shift problem, in terms of design, includes a main pixel and a sub pixel, and 4 domains are changed into 8 domains by pulling down a voltage of the sub pixel, to improve a viewing angle.

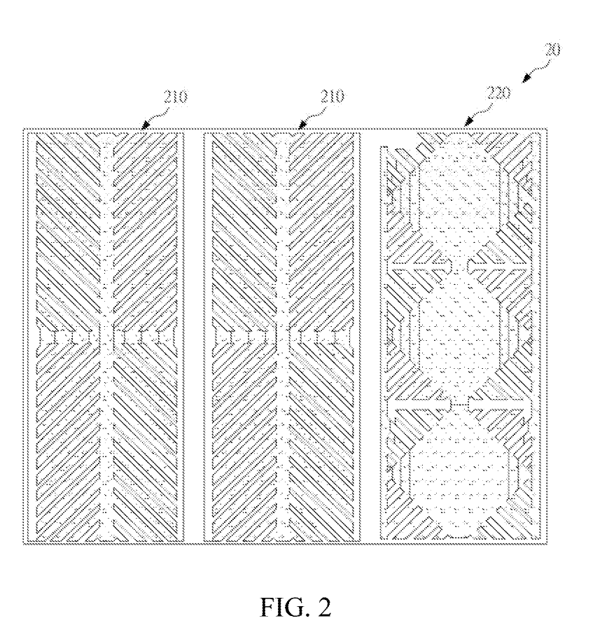

FIG. 2 is a schematic diagram of pixel arrangement according to an embodiment of this application. Referring to FIG. 1b and FIG. 2, in an embodiment of this application, an array substrate 20 includes: a substrate, having a display region and a wiring region; at least one active switch, disposed on the substrate; a plurality of scanning lines and a plurality of data lines, disposed on the substrate, where the scanning lines are electrically connected to a control end of the active switch, and the data lines are electrically connected to an input end of the active switch; a plurality of pixels 210 and 220, disposed on the display region and electrically connected to an output end of the active switch, where: the plurality of pixels 210 and 220 includes a VA pixel 210 and at least one polymer-stabilized VA pixel 220, where: the polymer-stabilized VA pixel 220 is a blue pixel; and a pixel electrode of the VA pixel 210 and a pixel electrode of the polymer-stabilized VA pixel 220 are separately electrically coupled to the substrate.

In an embodiment, the plurality of pixels comprises three pixels 210 and 220, including one polymer-stabilized VA pixel 220 and two VA pixels 210, and the polymer-stabilized VA pixel 220 further includes three polymer-stabilized VA sub pixels.

In an embodiment, the plurality of pixels comprises four pixels 210 and 220, including one polymer-stabilized VA pixel 220 and three VA pixels 210.

In an embodiment, the plurality of pixels comprises four pixels 210 and 220, including two polymer-stabilized VA pixel 220 and two VA pixels 210.

In an embodiment, the data line D1 provides voltage values of the VA pixel 210 and the polymer-stabilized VA pixel 220, so that the scanning lines G1 and G2 control on and off of the active switch according to the voltage values provided by the data line D1.

In an embodiment, indium tin oxide of the VA pixel 210 is not connected to indium tin oxide of the polymer-stabilized VA pixel 220, to prevent chaotic liquid crystal falling directions.

In an embodiment, the polymer-stabilized VA pixel 220 and the VA pixel 210 are connected to different data lines.

In an embodiment, the polymer-stabilized VA pixel 220 and the VA pixel 210 are connected to different scanning lines.

In an embodiment, the VA pixel 210 and the polymer-stabilized VA pixel 220 are arranged in an array form.

In an embodiment of this application, the VA pixel 210 and the polymer-stabilized VA pixel 220 are configured in a spaced manner or in a staggered manner.

Referring to FIG. 1b and FIG. 2, in an embodiment, an array substrate 20 includes: a substrate, having a display region and a wiring region; at least one active switch, disposed on the substrate; a plurality of scanning lines and a plurality of data lines, disposed on the substrate, where the scanning lines are electrically connected to a control end of the active switch, and the data lines are electrically connected to an input end of the active switch; a plurality of pixels 210 and 220, disposed on the display region and electrically connected to an output end of the active switch, where: the plurality of pixels 210 and 220 includes a VA pixel 210 and at least one polymer-stabilized VA pixel 220, where: the polymer-stabilized VA pixel 220 is a blue pixel; a pixel electrode of the VA pixel 210 and a pixel electrode of the polymer-stabilized VA pixel 220 are separately electrically coupled to the substrate; the VA pixel 210 and the polymer-stabilized VA pixel 220 are arranged in an array form; the VA pixel 210 and the polymer-stabilized VA pixel 220 are rectangular; and the VA pixel 210 and the polymer-stabilized VA pixel 220 are configured in a spaced and intersecting manner.

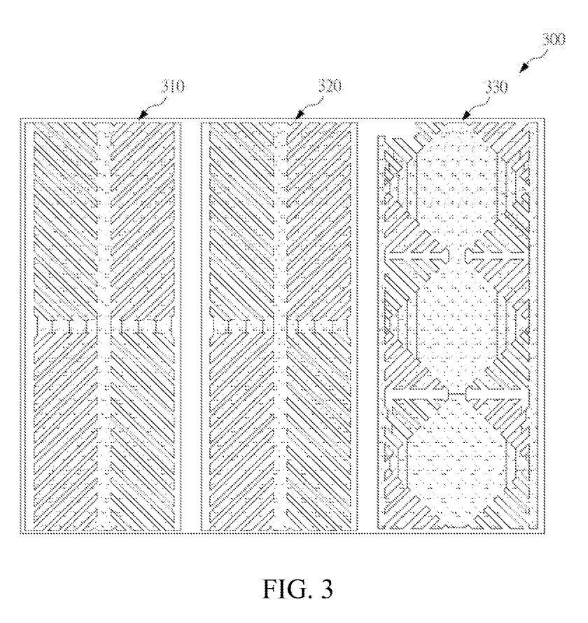

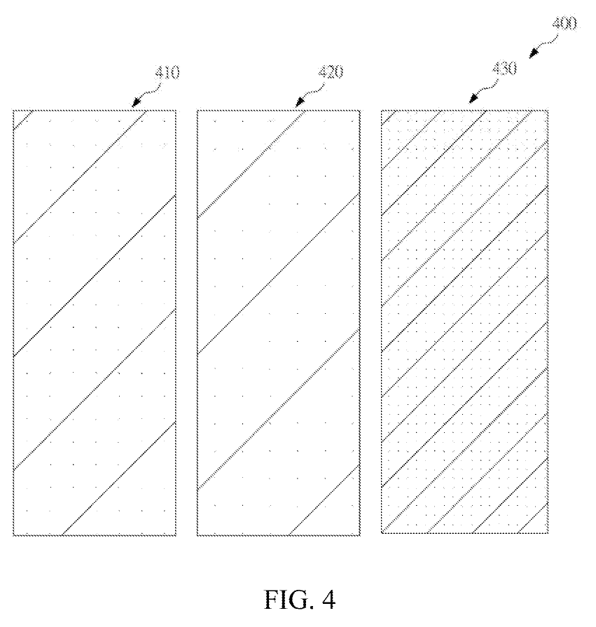

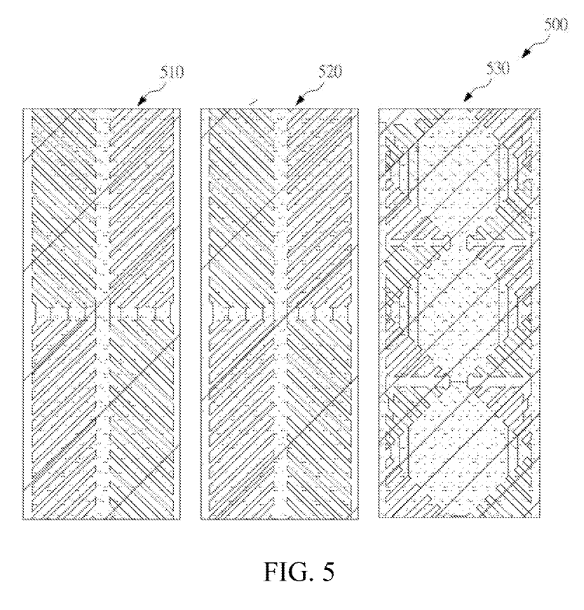

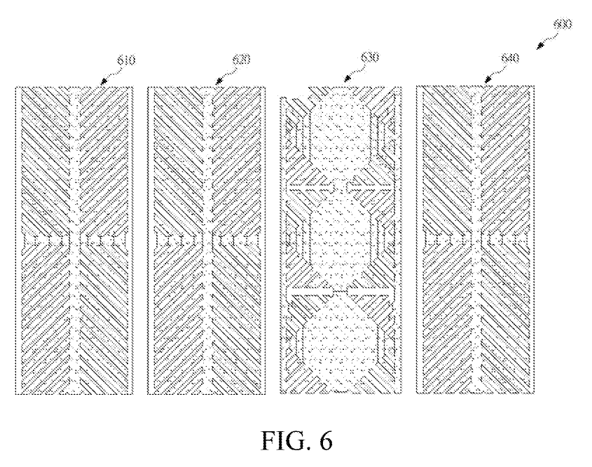

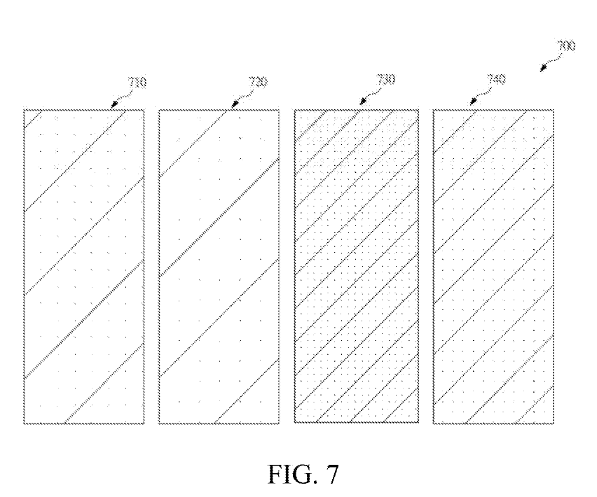

FIG. 3 is a schematic diagram of pixel arrangement according to another embodiment of this application, FIG. 4 is a schematic diagram of pixel arrangement according to another embodiment of this application, FIG. 5 is a schematic diagram of pixel arrangement according to still another embodiment of this application, FIG. 6 is a schematic diagram of pixel arrangement according to yet another embodiment of this application, and FIG. 7 is a schematic diagram of pixel arrangement according to yet still further another embodiment of this application. Referring to FIG. 2 and FIG. 3, in an embodiment of this application a display panel 300 includes a substrate (not shown in the figure); a CF, including a plurality of color resists (a red color resist 310, a green color resist 320, and a blue color resist 330), and the array substrate 20, where the color resists are configured on the substrate or the array substrate 20.

Referring to FIG. 4, in an embodiment of this application, a CF 400 including a VA pixel and a polymer-stabilized VA pixel includes: a red photoresist layer 410, a green photoresist layer 420, and a blue photoresist layer 430.

Referring to FIG. 5, in an embodiment of this application, an array substrate 500 including a VA pixel and a polymer-stabilized VA pixel applicable to a CF on the substrate includes: a red array substrate 510, a green array substrate 520, and a blue array substrate 530.

Referring to FIG. 2 and FIG. 6, in an embodiment of this application, a display panel 600 includes: an opposite substrate (not shown in the figure), disposed opposite to the array substrate 20; a CF, including a plurality of color resists (a red color resist 610, a green color resist 620, a blue color resist 630, and a white color resist 640), and the array substrate 20, where the CF is configured on the opposite substrate or the array substrate 20.

Referring to FIG. 2 and FIG. 6, in an embodiment, the color resists include a first color resist (the red color resist 610), a second color resist (the green color resist 620), a third color resist (the blue color resist 630), and a fourth color resist (the white color resist 640), where the third color resist (the blue color resist 630) and the second pixel domain 220 of the pixel unit are configured in a corresponding manner, and the first color resist (the red color resist 610), the second color resist (the green color resist 620), and the fourth color resist (the white color resist 640), and the first pixel domain 210 are configured in a corresponding manner.

Referring to FIG. 7, in an embodiment of this application, a CF 700 including a VA pixel and a polymer-stabilized VA pixel and applicable to red, green, blue, and white includes: a red photoresist layer 710, a green photoresist layer 720, a blue photoresist layer 730, and a white photoresist layer 740.

Referring to FIG. 1b and FIG. 2, in an embodiment of this application, a display panel includes: an array substrate 20, including: a substrate, having a display region and a wiring region; at least one active switch, disposed on the substrate; a plurality of scanning lines and a plurality of data lines, disposed on the substrate, where the scanning lines are electrically connected to a control end of the active switch, and the data lines are electrically connected to an input end of the active switch; a plurality of pixels 210 and 220, disposed on the display region and electrically connected to an output end of the active switch, where: the plurality of pixels 210 and 220 includes a VA pixel 210 and at least one polymer-stabilized VA pixel 220, where: the polymer-stabilized VA pixel 220 is a blue pixel; and a pixel electrode of the VA pixel 210 and a pixel electrode of the polymer-stabilized VA pixel 220 are separately electrically coupled to the substrate; an opposite substrate, disposed opposite to the array substrate 20; and a CF, including a plurality of color resists, where the CF is configured on the opposite substrate or the array substrate 20.

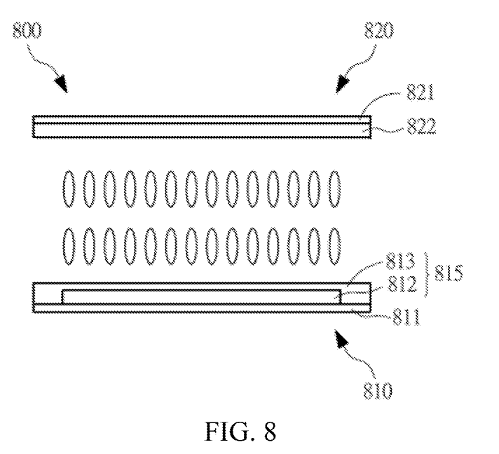

FIG. 8 is a schematic diagram of a display panel according to an embodiment of this application. Referring to FIG. 2 and FIG. 8, in an embodiment of this application, a display panel 800, includes an array substrate 810, including: a first substrate 811; a scanning line 812, formed on the first substrate 811 and configured to provide a scanning signal; a data line 813, formed on the first substrate 811 and configured to provide a data signal, where the data line 813 and the scanning line 812 define at least one pixel 815, or the pixels 210 and 220; and an opposite substrate 820, including a second substrate 821; and a transparent electrode layer 822, disposed on the second substrate 821, where the array substrate 810 and the opposite substrate 820 are disposed opposite to each other.

Referring to FIG. 8, in an embodiment of this application, a display panel 800 may be, for example, a QLED display panel, an OLED display panel, or an LCD display panel, and no limitation is imposed herein.

This application may resolve a large-viewing-angle color shift problem of a display panel and improve product competitiveness and consumer satisfaction.

The wordings such as “in some embodiments” and “in various embodiments” are repeatedly used. The wordings usually refer to different embodiments, but they may alternatively refer to a same embodiment. The words, such as “comprise”, “have”, and “include”, are synonyms, unless other meanings are indicated in the context thereof.

The foregoing descriptions are merely specific embodiments of this application, and are not intended to limit this application in any form. Although this application has been disclosed above through the specific embodiments, the embodiments are not intended to limit this application. Any person skilled in the art can make some variations or modifications, namely, equivalent changes, according to the foregoing disclosed technical content to obtain equivalent embodiments without departing from the scope of the technical solutions of this application. Any simple amendment, equivalent change, or modification made to the foregoing embodiments according to the technical essence of this application without departing from the content of the technical solutions of this application shall fall within the scope of the technical solutions of this application.

What is claimed is:

1. An array substrate, comprising:
a substrate, having a display region and a wiring region;
at least one active switch, disposed on the substrate;
a plurality of scanning lines and a plurality of data lines, disposed on the substrate, wherein the scanning lines are electrically connected to a control end of the active switch, and the data lines are electrically connected to an input end of the active switch; and
a plurality of pixel units, each of the pixel units comprising a plurality of pixels having different colors, disposed on the display region and electrically connected to an output end of the active switch, wherein:
the plurality of pixels comprises a vertical alignment (VA) pixel and at least one polymer-stabilized VA pixel, wherein:
the polymer-stabilized VA pixel is a blue pixel; and a pixel electrode of the VA pixel and a pixel electrode of the polymer-stabilized VA pixel are separately electrically coupled to the substrate.

2. The array substrate according to claim 1, wherein the plurality of pixels comprises three pixels, comprising one polymer-stabilized VA pixel and two VA pixels.

3. The array substrate according to claim 2, wherein the polymer-stabilized VA pixel further comprises three polymer-stabilized VA sub pixels.

4. The array substrate according to claim 1, wherein the plurality of pixels comprises fourth pixels, comprising one polymer-stabilized VA pixel and three VA pixels.

5. The array substrate according to claim 1, wherein the plurality of pixels comprises fourth pixels, comprising two polymer-stabilized VA pixels and two VA pixels.

6. The array substrate according to claim 1, wherein the VA pixel and the polymer-stabilized VA pixel are arranged in an array form.

7. The array substrate according to claim 1, wherein the polymer-stabilized VA pixel and the VA pixel are connected to different data lines.

8. The array substrate according to claim 1, wherein the polymer-stabilized VA pixel and the VA pixel are connected to different scanning lines.

9. The array substrate according to claim 1, wherein the VA pixel and the polymer-stabilized VA pixel are rectangular.

10. The array substrate according to claim 1, wherein the VA pixel and the polymer-stabilized VA pixel are configured in a spaced manner.

11. The array substrate according to claim 1, wherein the VA pixel and the polymer-stabilized VA pixel are configured in a staggered manner.

12. An array substrate, comprising:
a substrate, having a display region and a wiring region;
at least one active switch, disposed on the substrate;
a plurality of scanning lines and a plurality of data lines, disposed on the substrate, wherein the scanning lines are electrically connected to a control end of the active switch, and the data lines are electrically connected to an input end of the active switch; and
a plurality of pixels, disposed on the display region and electrically connected to an output end of the active switch, wherein:
the plurality of pixels comprises a vertical alignment (VA) pixel and at least one polymer-stabilized VA pixel, wherein: the polymer-stabilized VA pixel is a blue pixel; a pixel electrode of the VA pixel and a pixel electrode of the polymer-stabilized VA pixel are separately electrically coupled to the substrate; the VA pixel and the polymer-stabilized VA pixel are arranged in an array form; the VA pixel and the polymer-stabilized VA pixel are rectangular; and the VA pixel and the polymer-stabilized VA pixel are configured in a spaced and intersecting manner.

13. A display panel, comprising:
an array substrate, comprising:
a substrate, having a display region and a wiring region;
at least one active switch, disposed on the substrate;
a plurality of scanning lines and a plurality of data lines, disposed on the substrate, wherein the scanning lines are electrically connected to a control end of the active switch, and the data lines are electrically connected to an input end of the active switch; and
a plurality of pixel units, each of the pixel units comprising a plurality of pixels having different colors, disposed on the display region and electrically connected to an output end of the active switch, wherein:
the plurality of pixels comprises a vertical alignment (VA) pixel and at least one polymer-stabilized VA pixel, wherein:
the polymer-stabilized VA pixel is a blue pixel; and a pixel electrode of the VA pixel and a pixel electrode of the polymer-stabilized VA pixel are separately electrically coupled to the substrate;
an opposite substrate, disposed opposite to the array substrate; and
a color filter (CF), comprising a plurality of color resists, wherein
the CF is configured on the opposite substrate or the array substrate.

14. The display panel according to claim 13, wherein the plurality of pixels comprises three pixels, comprising one polymer-stabilized VA pixel and two VA pixels.

15. The display panel according to claim 14, wherein the polymer-stabilized VA pixel further comprises three polymer-stabilized VA sub pixels.

16. The display panel according to claim 13, wherein the plurality of pixels comprises four pixels, comprising one polymer-stabilized VA pixel and three VA pixels.

17. The display panel according to claim 13, wherein the plurality of pixels comprises four pixels, comprising two polymer-stabilized VA pixels and two VA pixels.

18. The display panel according to claim 13, wherein the VA pixel and the polymer-stabilized VA pixel are arranged in an array form.

19. The display panel according to claim 13, wherein the VA pixel and the polymer-stabilized VA pixel are configured in a spaced manner.

20. The display panel according to claim 13, wherein the VA pixel and the polymer-stabilized VA pixel are configured in a staggered manner.
